(19) United States
(12) Patent Application Publication
(10) Pub. No.: US 2026/0305649 A1
(43) Pub. Date: Oct. 8, 2026

(54) IMPROVEMENTS TO FLUENT MIXING MACHINES

(71) Applicant: CREMMJOY INC., Baton Rouge, LA (US)

(72) Inventors: Jason James Hugenroth, Baton Rouge, LA (US); Max Louis Lemoine, Baton Rouge, LA (US); Jared Keen Chaffee, Houston, TX (US)

(21) Appl. No.: 19/483,442

(22) PCT Filed: Jun. 5, 2024
(86) PCT No.: PCT/US2024/032579

§ 371 Date: Nov. 11, 2025

Related U.S. Application Data
(60) Provisional application No. 63/471,700, filed on Jun. 7, 2023.

(51) Int. Cl. A23G 9/12; A23G 9/22; A23G 9/28; B01F 31/31; B01F 35/212; B01F 35/75; B01F 35/90; B01F 35/92; B01F 101/13

(52) U.S. Cl. CPC A23G 9/12; A23G 9/224; A23G 9/28; B01F 31/312; B01F 35/212; B01F 35/7546; B01F 35/92; B01F 2035/98; B01F 2035/99; B01F 2101/13

(57) ABSTRACT

A system for mixing fluent material is shown. A number of features improve the operation of such systems. In some systems the fluent material may become semi-frozen. In other systems the fluent material may be heated.

### CROSS-REFERENCE TO RELATED APPLICATIONS

This application claims priority to U.S. Provisional Patent Application No. 63/471,700 filed on Jun. 7, 2023.

### STATEMENT REGARDING FEDERALLY SPONSORED RESEARCH OR DEVELOPMENT

This invention was made with Government Support under 2022-33610-37824 awarded by USDA-NIFA. The Government has certain rights in this invention.

### BACKGROUND

This application relates to improvements in devices for mixing liquids.

Applicant has recently developed machines which are utilized to mix air and cream to form a frozen confection, such as soft serve ice cream.

Embodiments are disclosed in Applicant's prior patent applications WO2020/163369A1 and WO2021/263113A1, both of which are expressly incorporated herein by reference. Liquid mix is received at a bottom of a freeze bag, and rollers move the liquid mix vertically upwardly through the freeze bag and against a heat exchanger. In one embodiment, the heat exchanger is a cold plate such that when the mix becomes frozen it moves the top of the bag.

While these machines provide valuable benefits, it would still be desirable to improve upon their operation.

### SUMMARY

In a featured embodiment, a machine for mixing and freezing a fluent material includes a flexible bag having a vertically lower inlet and a vertically higher outlet. A plurality of mixing rollers is driven to move vertically upwardly along the flexible bag and squeeze the flexible bag and mix a fluent material. A cold plate is on an opposed side of the flexible bag from the rollers such that the fluent material is subject to freezing temperatures as it moves upwardly toward the outlet. A non-freezing area is formed adjacent a vertically lower location such that the fluent material moves from a reservoir in a non-freezing area vertically beneath an inlet into the flexible bag, and without freezing until it reaches more vertically upward areas.

In another embodiment according to the previous embodiment, the non-cooling area is provided by a vertically lower extension of the cold plate formed of a material with a lower thermal conductivity than the cold plate such that it does not cool the fluent material.

In another embodiment according to any of the previous embodiments, the non-cooling area includes a heater.

In another embodiment according to any of the previous embodiments, the plurality of rollers move through a cyclic path, and extend into the non-freezing area.

In another featured embodiment, a machine for mixing a fluent material includes a flexible bag having a vertically lower inlet and a vertically higher outlet. A plurality of mixing rollers is driven to move vertically upwardly along the flexible bag and squeeze the flexible bag and mix a fluent material. A heat exchanger is on an opposed side of the flexible bag from the rollers such that the fluent material is subject to heat transfer as it moves upwardly towards the outlet. A relief structure is positioned at a vertically upper location of the flexible bag to provide relief to increased pressure from the fluent material as it moves vertically upwardly.

In another embodiment according to any of the previous embodiments, the outlet is on one lateral side of the flexible bag and a relief ear is formed on an opposed lateral side from the one lateral side such that the increased pressure of the fluent material is able to move into the ear to relieve over pressure.

In another embodiment according to any of the previous embodiments, a push roller rolls along the ear prior to the ear being reached by the next subsequent one of the plurality of mixing rollers, such that entrapped material in the ear is driven toward the outlet before the roller reaches the ear.

In another embodiment according to any of the previous embodiments, the relief member is a relief roller biased vertically downwardly, and separately from the plurality of mixing rollers and such that the relief rollers can move upwardly to provide the relief structure.

In another embodiment according to any of the previous embodiments, there is a single one of the relief roller.

In another embodiment according to any of the previous embodiments, there are segmented relief rollers which move independently.

In another embodiment according to any of the previous embodiments, the plurality of mixing rollers do not reach a top of the flexible bag.

In another embodiment according to any of the previous embodiments, the relief member is a relief in the heat exchanger at a vertically upper location to provide an area for the over pressure fluent material to move into.

In another embodiment according to any of the previous embodiments, the relief member is a take up roller positioned above the flexible bag. The take up roller is driven to move in a first direction when one of the plurality of mixing rollers is spaced further vertically lower, and driven in a second section to provide additional space in the flexible bag as the one of the plurality of mixing rollers approaches the vertically upper location.

In another embodiment according to any of the previous embodiments, the relief member is a heat exchanger plate biased extension contacting an opposed side of the flexible bag relative to the plurality of mixing rollers.

In another featured embodiment, a machine for mixing a fluent material includes at least one cartridge received within a cabinet, a mount structure for a flexible bag having a vertically lower inlet and vertically higher outlet. The cartridge includes a plurality of mixing rollers being driven to move vertically upwardly along the flexible bag to squeeze the flexible bag and mix a fluent material and a heat exchanger on an opposed side of the flexible bag from the rollers such that a fluent material is subject to heat transfer as it moves upwardly towards the outlet. The plurality of mixing rollers move in a cycle such that after moving toward a vertically upper position they move away from the flexible bag and then back vertically downwardly.

In another embodiment according to any of the previous embodiments, the plurality of mixing rollers are driven by a chain.

In another embodiment according to any of the previous embodiments, the at least one cartridge is removable from the cabinet as a unit to simplify maintenance.

In another embodiment according to any of the previous embodiments, there are at least two of the cartridges on opposed sides of the cabinet, with the heat exchangers of the two cartridges being adjacent to each other, with plurality of mixing rollers being on an opposed sides of the respective heat exchangers from the respective flexible bag.

In another embodiment according to any of the previous embodiments, the flexible bags are configured such that an inlet on one of the flexible bag sides is utilized as the outlet on the other of the flexible bags, and the outlet on the one of the flexible bags becomes the inlet on the other of the flexible bags.

In another embodiment according to any of the previous embodiments, there is a flap associated with the flexible bag which can be positioned on a side of the flexible bag that will contact the plurality of mixing rollers, with the flap providing a more robust surface to resist friction from the plurality of mixing rollers.

In another featured embodiment, a machine for mixing a fluent material includes a flexible bag having a vertically lower inlet and a vertically higher outlet. A plurality of mixing rollers is driven to move vertically upwardly along the flexible bag and squeeze the flexible bag and mix a fluent material. A heat exchanger is on an opposed side of the flexible bag from the plurality of mixing rollers such that the fluent material is subject to heat transfer to move upwardly toward the outlet. A sensor monitors a force in the flexible bag as the plurality of mixing rollers moves along the flexible bag. The force sensor communicates with the control.

In another embodiment according to any of the previous embodiments, there are a plurality of the force sensors.

In another featured embodiment, a machine for mixing a fluent material includes a first set of rollers driven to move along a first flexible bag to drive the first flexible bag along a first heat exchanger such that the fluent material is subject to heat transfer as it moves towards an outlet. A second set of mixing rollers is movable along a second flexible bag and holds the second flexible bag against a second heat exchanger such that fluent material in the second flexible bag is subject to heat transfer as it moves towards an outlet. An insulation member is intermediate the first and second heat exchanger and such that the first and second flexible bags are on an opposed sides of each other relative to the insulation member.

In another embodiment according to any of the previous embodiments, the first and second flexible bags are configured such that an inlet on one of the flexible bag sides is utilized as the outlet on the other of the flexible bags, and the outlet on the one of the flexible bags becomes the inlet on the other of the flexible bags.

In another embodiment according to any of the previous embodiments, the first and second heat exchangers are cold plates.

In another embodiment according to any of the previous embodiments, the fluent material in each of the first and second flexible bag is a semi-frozen confection product, and the semi-frozen confection product in the first and second flexible bag being different flavors.

These and other features will be best understood from the following drawings and specification, the following is a brief description.

### BRIEF DESCRIPTION OF THE DRAWINGS

FIG. 1 schematically shows a first machine according to this disclosure.

FIG. 2 shows a second embodiment machine.

FIG. 3 shows a fluent mixing machine.

FIG. 4A shows one cabinet removed from the FIG. 3 machine.

FIG. 4B shows an isometric view of a cartridge removed from the FIG. 4A cabinet.

FIG. 4C shows a front view.

FIG. 5 shows a challenge with the existing machines.

FIG. 6A shows an embodiment for addressing the FIG. 5 challenge.

FIG. 6B shows yet another alternative embodiment.

FIG. 6C shows yet another alternative embodiment for addressing the FIG. 5A challenge.

FIG. 6D shows another embodiment for addressing the FIG. 5 challenge.

FIG. 6E shows yet another embodiment for addressing the FIG. 5 challenge.

FIG. 6F is a front view of the FIG. 6E embodiment.

FIG. 6G shows another embodiment for addressing the FIG. 5 challenge.

FIG. 6H shows yet another embodiment for addressing the FIG. 5 challenge.

FIG. 6I shows yet another embodiment for addressing the FIG. 5 challenge.

FIG. 7A shows a dual cartridge machine having two side by side locations for dispensing a mixed material.

FIG. 7B shows a bag which may be utilized on both sides of the FIG. 7A machine.

FIG. 7C is a side view of the FIG. 7B bag.

FIG. 7D shows an alternative bag.

FIG. 7E shows an end view of the FIG. 7D bag.

FIG. 7F shows yet another embodiment reversible bag.

FIG. 7G shows the FIG. 7F bag as would be utilized.

FIG. 8A shows yet another feature incorporated into machines under this disclosure.

FIG. 8B shows yet another embodiment of a forced sensor.

FIG. 8C shows another force sensing embodiment.

FIG. 8D shows another force sensing embodiment.

### DETAILED DESCRIPTION

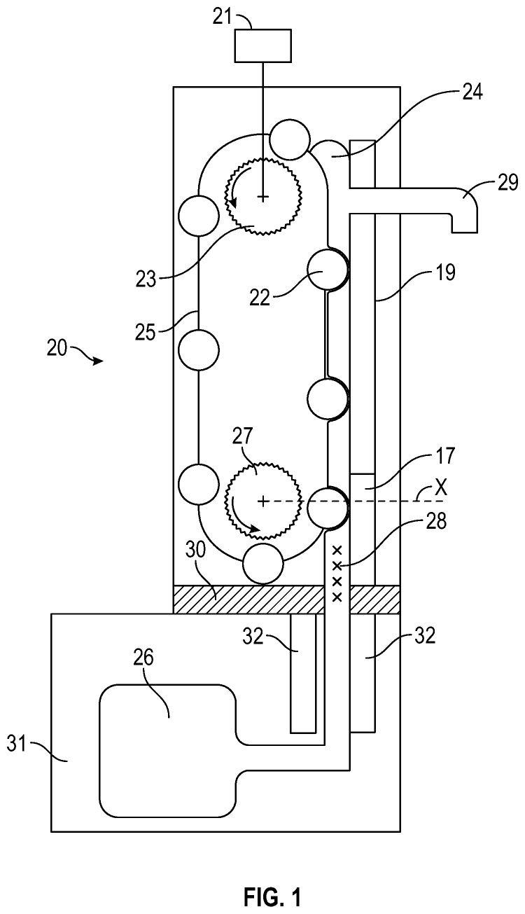

FIG. 1 shows a machine 20 having a plurality of rollers 22 which move along a bag 24 to mix and move a fluid material from an inlet 28, and outwardly of an outlet 29. While there is no distinction between bag 24 and the reservoir 26 shown in this Figure, in practice they would likely be different components having a connection around inlet 28. A divider 30 will slow heat transfer from a heat exchanger 19, which may be a cold plate. The housing will also be generally cooled. Without some means of limiting the cooling of the fluent material until it moves upwardly within the bag 24, it could freeze adjacent the inlet 28, which would be undesirable. The divider 30 provides a heat shield. Moreover, a lower portion 17 of the cold plate 19 may be formed of a plastic such that cooling of the fluent material is limited until it reaches more vertically upward areas. It should be clearly understood that many fluent materials such as ice cream mixes don't have well defined freezing or solidification points. Rather, their viscosity increases as their temperature decreases. In this application the term “frozen” refers to a fluent material more viscous than a “non-frozen” fluent material, whereas non-frozen does not necessitate the complete absence of ice crystals. Also, dependent on the material, solidification can occur even above room temperature.

As shown in FIG. 1, a motor 21, shown schematically, drives a sprocket 23 to move a chain 25 and the rollers 22. Another sprocket 27 also assists in moving the chain 25. A center axis of sprocket 27 defines a line X. Below this line the bag will not be fully pinched by the rollers 22. Further, there is an area between divider 30 and the line X which is susceptible to freezing at an undesirably early point, and is addressed as explained below.

In addition, support members 32 may be provided within a non-frozen zone 31. The support members 32 could be temperature controlled, namely as heating elements, such that the fluent material will not freeze until it moves further vertically upwardly into the bag 24.

The support member 32 also could constrain the bag 24 so that a limited amount of liquid mix is contained in the bottom of the bag 24. The support members 32 may be continuous from below freezing zone, or could contain a break or gap to accommodate the divider 30.

As can be appreciated from FIG. 1, the rollers 22 force opposed sides of the bag 24 to contact each other.

Freezing of the mixed liquid occurs at inner surfaces of the bag. The rollers crush or otherwise dislodge ice crystals as they form, which keeps the ice crystals from growing too large. Small ice crystals are desirable to give ice cream a smooth, creamy consistency. In general, the individual rollers do not extend the full width of the bag. This is to provide a flow path around the roller's edge. This is beneficial for churning the mix to produce overrun (small air or gas bubbles dispersed in the mix). It also provides a flow path for the mix in the bag when dispensing is not occurring, for example, when outlet 29 is closed. Although a single roller does not traverse the full width of the bag, there are multiple rollers in spaced relation such that the full width of the bag is traversed. The general operating principle and arrangement of the rollers and the rolled plate heat exchanger are detailed in the prior PCT applications mentioned above.

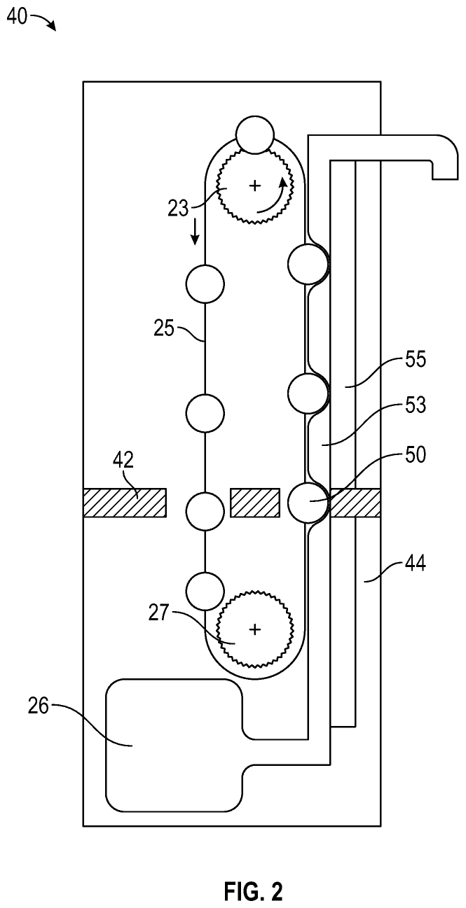

FIG. 2 shows an alternative embodiment 40 having the reservoir 26 providing fluent material into a bag 53, sprockets 23/27, chain 25 and rollers 50 moving along the bag 53 and holding it against the cold plate 55.

While a cold plate is specifically disclosed, it should be understood that some embodiments and features disclosed in this application could provide means for heating a fluent material while it is being mixed. As one example, it can be used to heat highly viscous liquids where mechanical mixing is needed to achieve good heat transfer. In general, it can be used in many applications where scraped surface heat exchanges are currently used.

In the FIG. 2 embodiment, a roller assembly includes rollers 50 extending into non-frozen area 44.

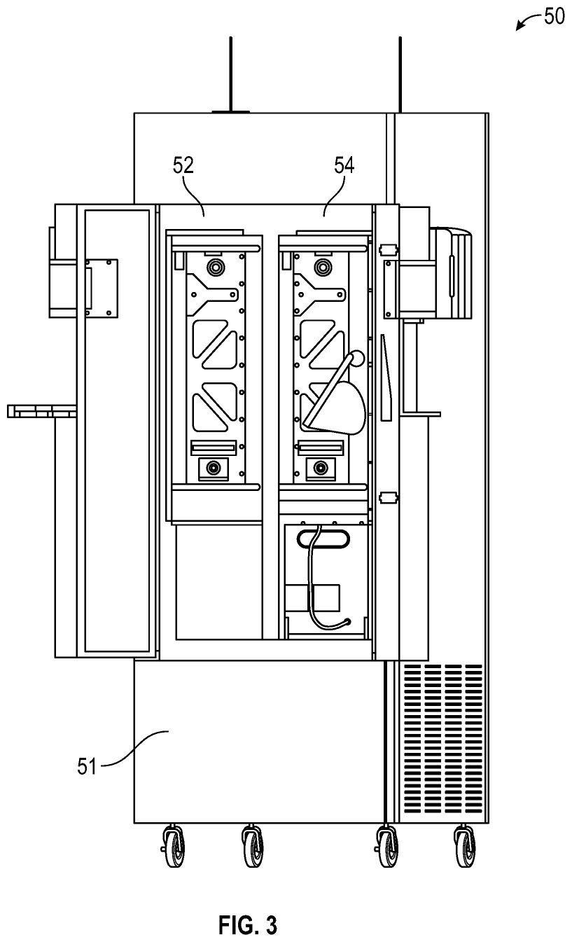

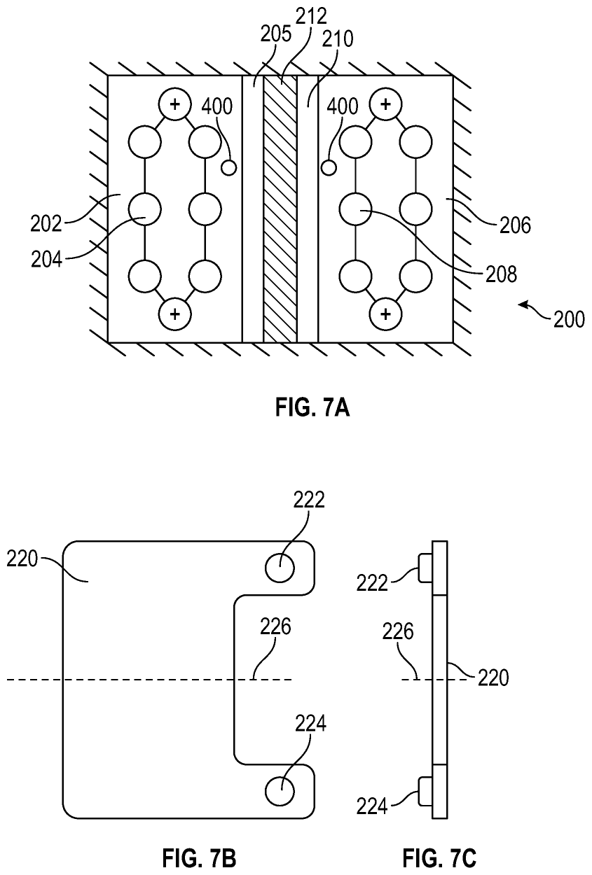

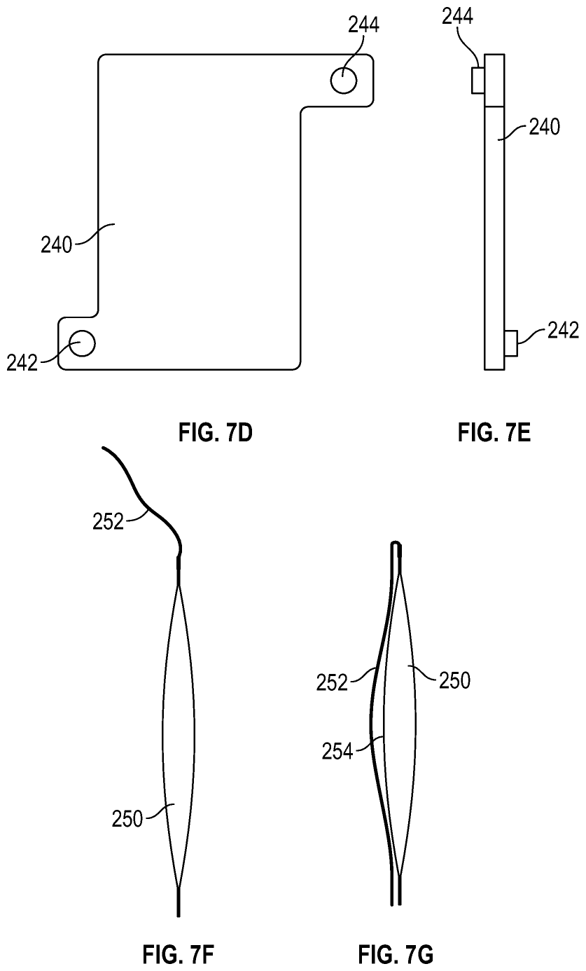

FIG. 3 shows a fluent mixing machine 50 having two cabinets 52 and 54 within a closed housing 51. The cabinets 52 and 54 receive cartridges as disclosed below and in particular at FIG. 7A.

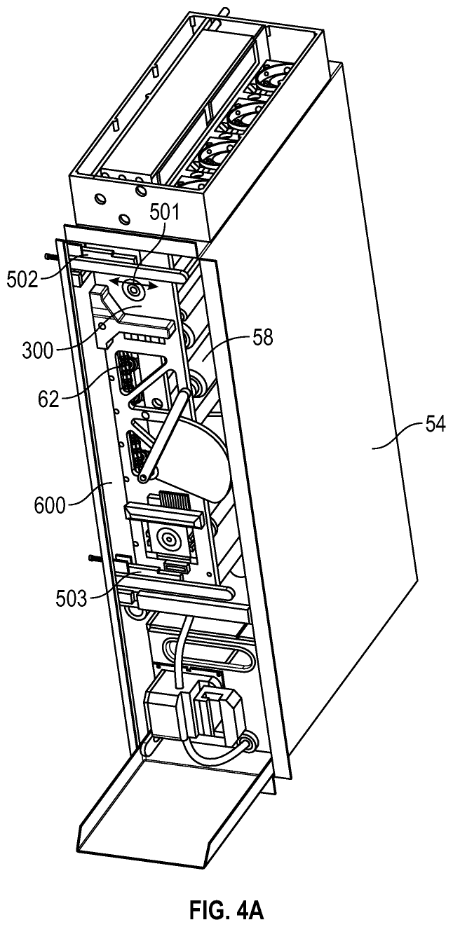

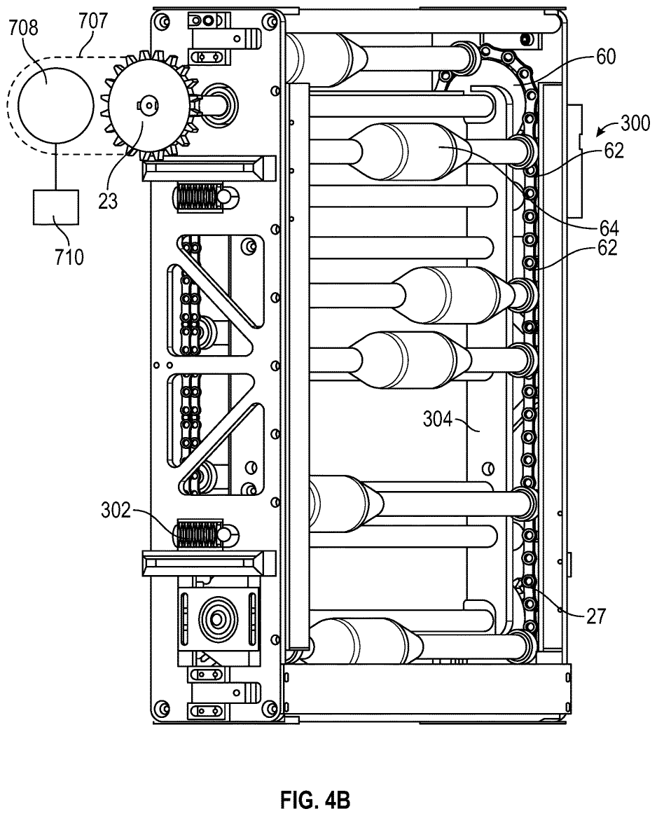

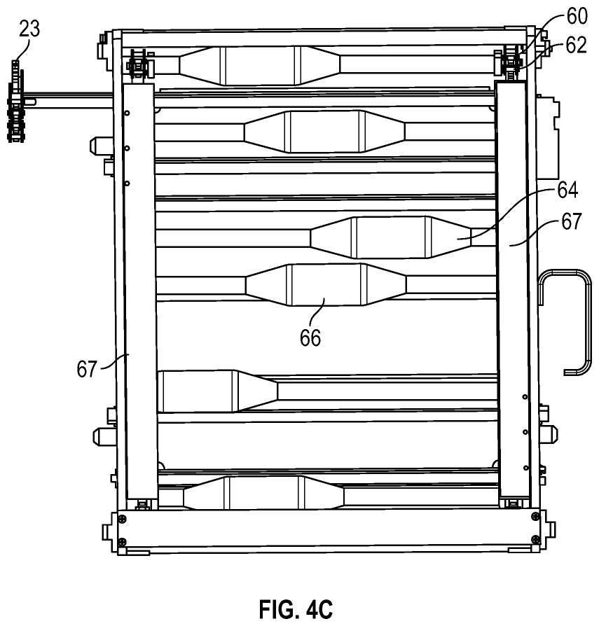

FIG. 4A shows details of cabinet 54 with a cartridge 300. There are rollers 58 within a cabinet 54.

Cartridge 300 can move in cabinet 54 in the directions depicted by arrow 501. This facilitates loading of the bag. For loading the bag, the cartridge is first moved away from the cold plate 600. The bag is mounted, then the cartridge 300 is moved toward the cold plate 600. Latches 502 and 503 are selectively engaged to hold the cartridge 300 in the proper position in the cabinet 54 such that rollers 58 properly pinch the bag.

FIG. 4B is an isometric view of a cartridge 300 showing the sprocket 23 which assists in driving the chain 62 to move a plurality of rollers 64 vertically upwardly, then back along a rear area, such that the rollers continue to move in a loop.

Guide rails 304 are shown biased by springs 302 against the roller assembly, to force the rollers 64 into the bag. As shown schematically, the sprocket 23 is driven by a chain 707 driven by a motor sprocket 708. An electric motor 710 drives motor sprocket 708.

FIG. 4C shows another view of the rollers 64, and 66. Sprocket 23 drives chain 62. A shield 67 protects the bag 24 from the chain 62. As can be seen the rollers 66 and 64 are laterally spaced such that the interaction between the roller and bag occurs at different lateral locations.

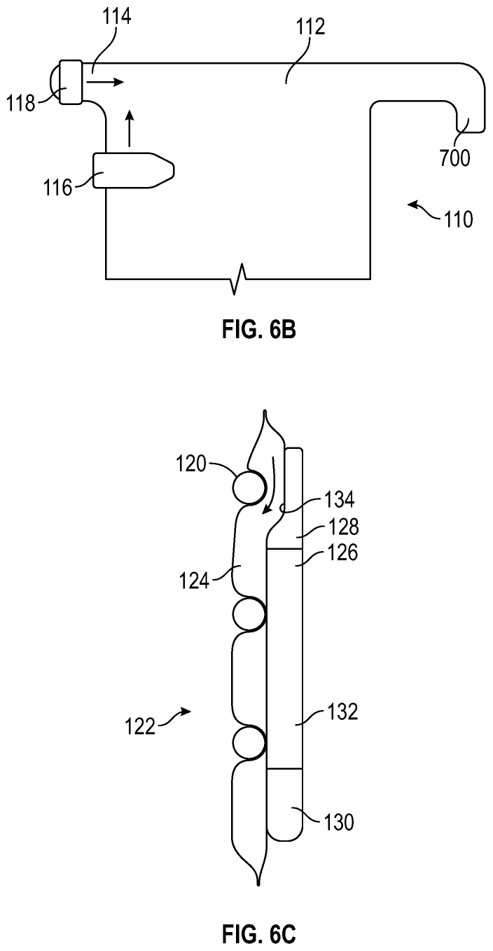

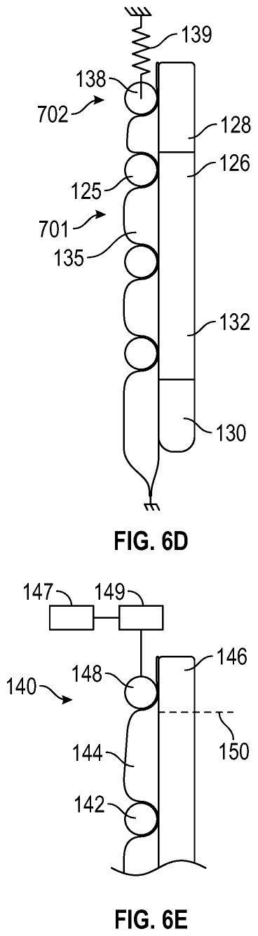

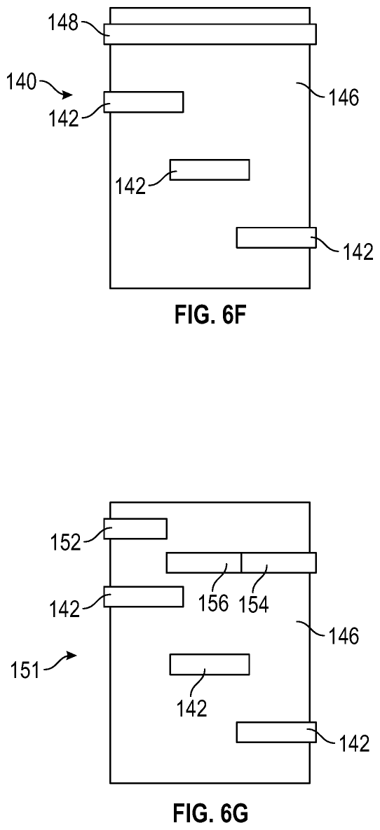

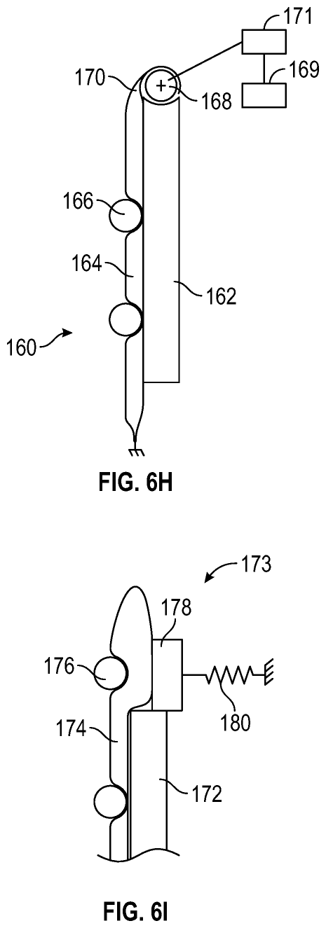

The cartridges 300 can be removed as a unit without significant disassembly. This is beneficial for cleaning and maintenance. As an example, should a bag rupture, and the enclosed mix contaminate the components of the roller assembly, the roller assembly could be sprayed with cleaning fluids, such as water, for easy cleaning. The cassette design also makes periodic maintenance such as lubricating or replacing worn components easier. When the mix in the bag is liquid, it flows easily around the edges of the roller. However, as the mix freezes its viscosity increases substantially, which greatly increases flow resistance. This, in turn, substantially increases the pressure and stresses on the bag in the vicinity of the roller and generates an upward pull or force on the entire bag, which can be substantial. The stresses on the bag become more substantial as the roller approaches the upper end of the bag. Thus, features such as shown in FIGS. 6A-6I may be incorporated.

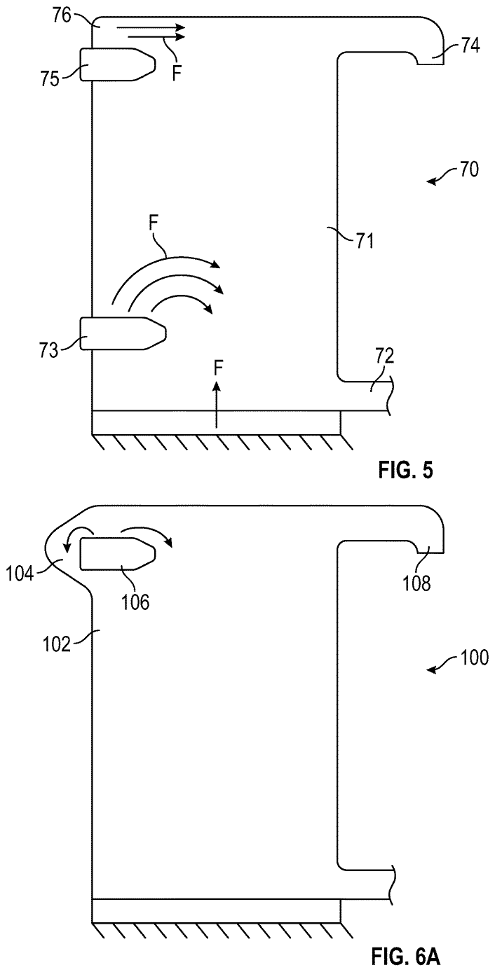

FIG. 5 shows a feature 70 which is a challenge that occurs with the existing machines. Here a bag 71 is shown having an inlet 72 and an outlet 74. A roller 73 is shown schematically moving vertically upwardly. The flow area F from the vertically lower roller 73 can be seen to extend vertically upwardly. In contrast, as the roller 75 approaches the vertical top 76 of the bag 71 there is less room for the flow F to move vertically upwardly. This can create high pressure, which would be undesirable.

FIG. 6A shows an embodiment for dealing with the pressure near the vertically upper ends at 100. Here the bag 102 is shown having a roller 106 approaching the vertically upper area. A relief zone or ear 104 is shown to the side of the roller 106, remote from the outlet 108. This provides additional flow area to relieve the pressure as described above with regard to FIG. 5.

FIG. 6B shows another embodiment 110 wherein a bag 112 has a roller 116 approaching a vertically upper area with ear 114 as in the FIG. 6A embodiment. In addition, a push roller 118 is rolling the mixed fluent material toward the outlet 700. Again, the roller 118 and relief area 114 are on an opposed side of roller 116 from outlet 700.

The push roller 118 rolls along the ear 114 prior to the ear being reached by the next subsequent one of the plurality of mixing rollers and such that entrapped material in the ear is driven toward the outlet before the roller reaches the ear.

FIG. 6C shows yet another embodiment 122 wherein the bag 124 is associated with rollers 120. Here, the cold plate 126 is shown having a plastic area 130, as described below, which assists in preventing freezing until the fluent material moves further upwardly into the bag 124. A central area 132 acts as the cold plate, and another plastic area 128 is formed at the upper end. A relief 134 is formed in the upper area 128 to provide relief for the pressure as described above.

The plastic components 128 and 130 may be of any material with low thermal conductivity. As an example, it could also be a high thermal conductor with insulation between the cold plate and the extensions 128 and 130. The purpose of the lower plastic area 130 is to prevent the mixture from freezing near the bag inlet, which could prevent non-frozen mix from entering the bag. The purpose of the upper plastic portion 128 is to prevent the material from getting too cold or viscous, which can over stress the bag 124 and retard dispensing from the outlet. While the areas are shown in this embodiment, they may also be included in other embodiments such as the FIGS. 1 and 2 embodiments.

FIG. 6D shows another embodiment 701 wherein the rollers 125 move along the freeze bag 135. At an upper area 702 a relief roller 138 is biased by spring 139 to provide pressure relief and drive the excess fluent material downward.

As can be appreciated, as the roller 125 approaches the vertically upper end, the force on the relief roller 138 will increase. The relief roller may then move upwardly against the bias of spring 139 to provide additional area.

FIG. 6E shows an embodiment 140 wherein a relief roller 148 provides pressure relief in the bag 144 as the roller 142 approaches the top area. Note, there is an upper limit 150 which is the maximum upper position that the mixing roller 142 will reach. The same upper limit occurs in the FIG. 6D embodiment.

In FIG. 6E, an actuator 149 may apply a bias against the roller 148, and is actuated by a control 147 to move away from the illustrated position to provide more area in the bag 144 as the mix roller 142 approaches the area.

FIG. 6F shows the embodiment 140 having the relief roller 148 and rollers 142. Relief roller 148 extends across the entire lateral width of the bag 146. As can be appreciated, the rollers 142 are all at distinct lateral locations across the bag 146.

FIG. 6G shows an embodiment 151 wherein the relief roller is formed of a plurality of segmented relief rollers 152, 154 and 156. Here again, bag 146 has a plurality of mixing rollers 142 moving as described above.

FIG. 6H shows an embodiment 160 wherein a take up roller 168 is driven to take up slack in the bag 164 adjacent the upper end 170 of the bag 164 as the roller 166 drives the fluent mixture toward the outlet.

As shown, a motor 171 is controlled by a control 169 to drive the take up roller 168. When the mixing roller 166 is spaced further from the take up roller 168 the motor 171 may be controlled to turn the take up roller 168 in a first direction to tighten the flexible bag 170. However, as the mixing roller 166 approaches the take up roller 168, the take up roller 168 is driven in an opposed direction to provide more flexible bag space. Alternatively, a torsional spring on take up roller 168 can replace the motor 171 and control 169.

In each of the embodiments of FIGS. 6D-6H, the mixing rollers will not move as high vertically upwardly to reach the location of the relief or take up roller.

FIG. 6I shows yet another embodiment 173 wherein the cold plate 172 is associated with the bag 174 and mixing rollers 176. A cold plate extension 178 is spring biased 180 toward the bag 174 such that as the pressure rises the extension 178 can be driven away from the bag 174 to allow pressure relief.

FIG. 7A shows an embodiment 200 wherein there are two cabinets 202 and 206 on lateral sides of the overall machine, and as shown in FIG. 3. Rollers 204 move within cabinet 202 and rollers 208 move within cabinet 206. Ideally, rollers 204 and 208 are assembled in cartridges, not depicted. Cold plates 205 and 210 are shown on each side of an insulation member 212.

The arrangement depicted in FIG. 7A is advantageous particularly when used for frozen confection fluent materials such as soft serve ice cream. It permits two flavors of soft serve in a single machine while limiting the overall width of the machine. It also, brings the outlet 400 in close proximity, which is ideal for dispensing both flavors into a single container.

FIG. 7B shows a bag 220 which may be utilized in the machine 200. As shown, the bag 220 is generally symmetrical about a central axis 226. One port 222 and a second port 224 provide the inlet and/or the outlet.

As shown in FIG. 7C, the bag 220 has mirror symmetry, about the line of symmetry 226. The use of the symmetrical bag 220 allows the same bag design to be utilized in the machine 200 on each side.

FIG. 7D shows another bag embodiment where 180° in plane rotation allows it to be utilized on either side. Here ports 242 and 244 are shown, and can be used on both sides of the embodiment 200.

As shown in FIG. 7E, the ports 242 and 242 may extend from opposed sides of the bag 240. The bag 240 is shown to be otherwise symmetric. When rotated port 242 would be top right and port 244 bottom left. Thus, the same bag can be used on both side cartridges.

FIG. 7F shows another bag embodiment 250 where there is a protective flap material 252. As shown in FIG. 7G protective flap material can be put on a side 254 that will see contact with the roller. By having the flap, the bag 250 can be used on either side of the machine of embodiment 200. The flap 252 can extend from the lower or upper end of the bag 250 as necessary.

Applicant has recognized that it is desirable to be able to determine a pressure within the flexible bag, since this can provide an indication of when the fluent material is properly at least partially frozen, and when it may be time to add additional mix to the flexible bag, for example. The pressures in the flexible bag will be different at different locations. For example, when the product mix is being chilled toward and at least partially mixed, the pressures near the top of the flexible bag get quite high as the plurality of mixing rollers urge the partially frozen mix upwardly. At the same time, the pressure in a lower end of the bag will typically be much lower. The pressure in the lower end of the bag would be due mostly to the hydrostatic pressure of any liquid in the bag, and static pressure due to pressurization of the liquid mix and air. It can be difficult to get an accurate measure of the pressure within the flexible bag for several reasons. First, it would be desirable for the pressure sensor to only contact an outer surface of the flexible bag or an extensions of the flexible bag such as a tab or tube. This would eliminate the need for cleaning and sanitizing the pressure sensor. Also, the at least partially frozen product within the flexible bag can distort pressure readings. The movement of the mixing rollers over the flexible bag will cause the pressure to fluctuate in the flexible bag. In addition, the upward pull on the flexible bag due to the plurality of mixing rollers puts the flexible in significant tension which impedes pressure readings.

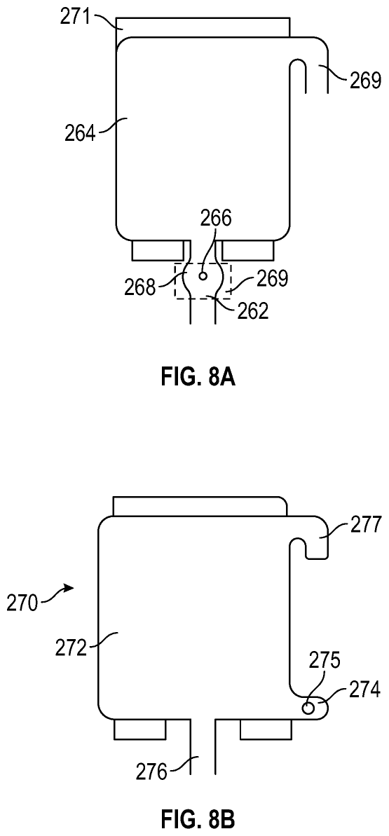

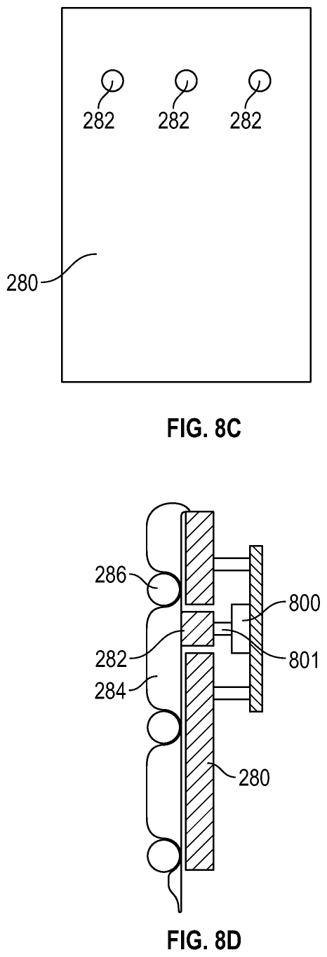

As shown in FIG. 8A, a bag 264 is provided with an extension 262 having an area 268 situated in close proximity to a force sensor 266.

Support plates, shown schematically at 269 fixes the position of the force sensor 266 and properly aligns and constrains extension 262. The support plates are arranged to facilitate loading of the flexible bags and may be desirably movable or removable. The plates can also contain temperature control elements such as heaters. Fluid pressure in the flexible bag causes the bag to inflate, including the extension 262. This inflation puts a force on the force sensor 266, which can be correlated with a pressure within the flexible bag 264.

The force on the sensor is calibrated to the pressure in the bag. When the pressure reading drops below a cut-in pressure the mix pump and air compressor turn on until a cut-out pressure is reached.

FIG. 8B shows another embodiment 270 wherein the bag 272 has an inlet 276, an outlet 277, and an ear 274 to a lateral side that will receive the sensor 275.

FIG. 8C shows a front view of yet another sensor embodiment having a plurality of laterally spaced force sensors 800 that interface with sensor ends 282 in the cold plate 280.

FIG. 8D shows a side section view of the FIG. 8C embodiment. Here rollers 286, bag 284 and cold plate 280 operate generally as described. The sensor 800 senses the firmness of the ice cream in the bag, and this can be used by a control to turn the roller and refrigerant system on and off. It may also provide a warning if the stress on the bag becomes too high.

As shown in FIG. 8D, sensor 800 has a sensing end 282 that contacts the bag 284. The sensing end 282 can have a variety of shapes and relative positions with respect to the plane of the cold plate 280. Pressure in the bag 284 results in transmission of force from the sensing end 282 to the sensor 800.

In embodiment, the sensors may be load cells, such as strain gauges or piezoelectric devices. It should be understood that while a housing for the sensor 800 is fixed, the internal components may move slightly. Sensor extension 801 is depicted as a physical link between the sensing end 282 and sensor 800. This could also be a non-physical link. In this case, a sensor 800 could be one of several types of non-contact proximity probes known in the art. In this case the sensor 800 detects changes in distance between the sensing end 282 and the sensor 800. The sensing end 282 could be a component on the bag 284 or could be the bag itself

Although several embodiments have been disclosed, a worker of skill within this art would recognize that many modifications would come within the scope of this disclosure. Thus, the following claims should be studied to determine the true scope and content of this disclosure.

1. A machine for mixing and freezing a fluent material comprising:
a flexible bag having a vertically lower inlet and a vertically higher outlet, a plurality of mixing elements being driven to move vertically upwardly along the flexible bag and squeeze the flexible bag and mix a fluent material, and a cold plate on an opposed side of the flexible bag from the elements such that the fluent material is subject to freezing temperatures as it moves upwardly toward the outlet; and
a non-freezing area formed adjacent a vertically lower location such that the fluent material moves from a reservoir in a non-freezing area vertically beneath an inlet into the flexible bag, and without freezing until it reaches more vertically upward areas.

2. The machine as set forth in claim 1, wherein the non-cooling area is provided by a vertically lower extension of the cold plate formed of a material with a lower thermal conductivity than the cold plate such that it does not cool the fluent material.

3. The machine as set forth in claim 1, wherein the non-cooling area includes a heater.

4. The machine as set forth in claim 1, wherein the plurality of elements move through a cyclic path, and extend into the non-freezing area.

5. A machine for mixing a fluent material comprising:
a flexible bag having a vertically lower inlet and a vertically higher outlet, a plurality of mixing elements being driven to move vertically upwardly along the flexible bag and squeeze the flexible bag and mix a fluent material, and a heat exchanger on an opposed side of the flexible bag from the elements such that the fluent material is subject to heat transfer as it moves upwardly towards the outlet; and
a relief structure positioned at a vertically upper location of the flexible bag to provide relief to increased pressure from the fluent material as it moves vertically upwardly.

6. The machine as set forth in claim 5, wherein the outlet is on one lateral side of the flexible bag and a relief ear is formed on an opposed lateral side from the one lateral side such that the increased pressure of the fluent material is able to move into the ear to relieve over pressure.

7. The machine as set forth in claim 6, wherein a push roller rolls along the ear prior to the ear being reached by the next subsequent one of the plurality of mixing elements, such that entrapped material in the ear is driven toward the outlet before the element reaches the ear.

8. The machine as set forth in claim 5, wherein the relief member is a relief roller biased vertically downwardly, and separately from the plurality of mixing elements and such that the relief rollers can move upwardly to provide the relief structure.

9. The machine as set forth in claim 8, wherein there is a single one of the relief roller.

10. The machine as set forth in claim 8, wherein there are segmented relief rollers which move independently.

11. The machine as set forth in claim 8, wherein the plurality of mixing elements do not reach a top of the flexible bag.

12. The machine as set forth in claim 5, wherein the relief member is a relief in the heat exchanger at a vertically upper location to provide an area for the over pressure fluent material to move into.

13. The machine as set forth in claim 5, wherein the relief member is a take up roller positioned above the flexible bag, the take up roller being driven to move in a first direction when one of the plurality of mixing elements is spaced further vertically lower, and driven in a second section to provide additional space in the flexible bag as the one of the plurality of mixing elements approaches the vertically upper location.

14. The machine as set forth in claim 5, wherein the relief member is a heat exchanger plate biased extension contacting an opposed side of the flexible bag relative to the plurality of mixing elements.

15. A machine for mixing a fluent material comprising:
at least one cartridge received within a cabinet, a mount structure for a flexible bag having a vertically lower inlet and vertically higher outlet; and
the cartridge including a plurality of mixing elements being driven to move vertically upwardly along the flexible bag to squeeze the flexible bag and mix a fluent material and a heat exchanger on an opposed side of the flexible bag from the elements such that a fluent material is subject to heat transfer as it moves upwardly towards the outlet;
the plurality of mixing elements moving in a cycle such that after moving toward a vertically upper position they move away from the flexible bag and then back vertically downwardly.

16. The machine as set forth in claim 15, wherein the plurality of mixing elements are driven by a chain.

17. The machine as set forth in claim 16, wherein the at least one cartridge is removable from the cabinet as a unit to simplify maintenance.

18. The machine as set forth in claim 17, wherein there are at least two of said cartridges on opposed sides of the cabinet, with the heat exchangers of the two cartridges being adjacent to each other, with plurality of mixing elements being on an opposed sides of the respective heat exchangers from the respective flexible bag.

19. The machine as set forth in claim 18, wherein the flexible bags are configured such that an inlet on one of the flexible bag sides is utilized as the outlet on the other of the flexible bags, and the outlet on the one of the flexible bags becomes the inlet on the other of the flexible bags.

20. The machine as set forth in claim 18, wherein there is a flap associated with the flexible bag which can be positioned on a side of the flexible bag that will contact the plurality of mixing elements, with the flap providing a more robust surface to resist friction from the plurality of mixing elements.

21. A machine for mixing a fluent material comprising:
a flexible bag having a vertically lower inlet and a vertically higher outlet, a plurality of mixing elements being driven to move vertically upwardly along the flexible bag and squeeze the flexible bag and mix a fluent material, and a heat exchanger on an opposed side of the flexible bag from the plurality of mixing elements such that the fluent material is subject to heat transfer to move upwardly toward the outlet; and
a sensor for monitoring a force in the flexible bag as the plurality of mixing elements moves along the flexible bag, and the force sensor communicating with the control.

22. The machine as set forth in claim 21, wherein there are a plurality of the force sensors.

23. A machine for mixing a fluent material comprising:
a first set of mixing elements driven to move along a first flexible bag to drive the first flexible bag along a first heat exchanger such that the fluent material is subject to heat transfer as it moves towards an outlet;
a second set of mixing elements movable along a second flexible bag and holding the second flexible bag against a second heat exchanger such that fluent material in the second flexible bag is subject to heat transfer as it moves towards an outlet; and
an insulation member intermediate the first and second heat exchanger and such that the first and second flexible bags are on an opposed sides of each other relative to the insulation member.

24. The machine as set forth in claim 23, wherein the first and second flexible bags are configured such that an inlet on one of the flexible bag sides is utilized as the outlet on the other of the flexible bags, and the outlet on the one of the flexible bags becomes the inlet on the other of the flexible bags.

25. The machine as set forth in claim 23, wherein the first and second heat exchangers are cold plates.

26. The machine as set forth in claim 25, wherein the fluent material in each of the first and second flexible bag is a semi-frozen confection product, and the semi-frozen confection product in the first and second flexible bag being different flavors.

27. The machine as set forth in claim 1, wherein the plurality of mixing elements are rollers.

28. The machine as set forth in claim 5, wherein the plurality of mixing elements are rollers.

29. The machine as set forth in claim 15, wherein the plurality of mixing elements are rollers.

30. The machine as set forth in claim 21, wherein the plurality of mixing elements are rollers.

31. The machine as set forth in claim 23, wherein the plurality of mixing elements are rollers.
